(19) United States
(12) Patent Application Publication
(10) Pub. No.: US 2009/0214916 A1
(43) Pub. Date: Aug. 27, 2009

(54) ELECTRONIC APPARATUS SYSTEM

(75) Inventor: Tomohiro Hirayama, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/388,161

(22) Filed: Feb. 18, 2009

(30) Foreign Application Priority Data
Feb. 22, 2008 (JP) 2008-041869

(51) Int. Cl. H01M 8/04; H01M 2/02

(52) U.S. Cl. 429/26; 429/34

(57) ABSTRACT

According to one embodiment, an electronic apparatus system comprises an electronic apparatus including a heating member, and a fuel cell apparatus including a electromotive section configured to generate electricity by a chemical reaction, a fuel tank, a circulation system including a fuel channel and an air channel, and a gas-liquid separator. The gas-liquid separator is arranged between a flow-out end of the electromotive section and the fuel tank in the fuel channel, configured to separate a gas-liquid two-phase fluid discharged from the anode to a liquid and gas, and is thermally coupled to the heating member to be heated by the heat of the heating member.

### CROSS-REFERENCE TO RELATED APPLICATIONS

This application is based upon and claims the benefit of priority from Japanese Patent Application No. 2008-041869, filed Feb. 22, 2008, the entire contents of which are incorporated herein by reference.

### BACKGROUND

1. Field

One embodiment of the present invention relates to an electronic apparatus system having an electronic apparatus and a fuel cell apparatus for supplying a current to the electronic apparatus.

2. Description of the Related Art

At present, secondary batteries such as a lithium ion battery are mainly used as a power supply of mobile electronic apparatus such as a notebook computer. Recently, a compact fuel cell, which has a high output and need not be charged, is expected as a novel power supply in response to a requirement for an increase of power consumption and a use of a longer time as a function of an electronic apparatus is more sophisticated. Although fuel cells have various types, attention is particularly paid to a direct methanol fuel cell (hereinafter, called DMFC), using a methanol solution as a fuel, as a power supply of electronic apparatus because the fuel can be more easily treated than a fuel cell using hydrogen as a fuel and the system is simple.

Usually, a DMFC is provided with a fuel tank that contains methanol, a liquid pump that force-feeds the methanol to an electromotive section, an air pump that supplies air to the electromotive section, etc. The electromotive section is provided with a cell stack composed of laminated single cells, each including an anode and a cathode. As the methanol and air are supplied to the anode and cathode sides, respectively, electricity is generated by a chemical reaction. As reaction products that are produced by the electricity generation, unreacted methanol and carbon dioxide are generated on the anode side of the electromotive section, and water on the cathode side. The water as a reaction product is reduced to steam and discharged.

In a gas-liquid two-phase fluid of the unreacted fuel and the carbon dioxide gas produced in the anode, the carbon dioxide gas disturbs an electricity generation reaction. Accordingly, when the unreacted fuel produced in the anode is circulated and reused, it is necessary to separate and remove a gas component in the gas-liquid two-phase fluid. According to, for example, a fuel cell disclosed in Jpn. Pat. Appln. KOKAI Publication No. 2005-108718, a gas-liquid separator is provided in a channel extending between an outlet of the anode of an electromotive section and a fuel tank. Unreacted methanol and carbon dioxide gas generated on the anode side of the electromotive section are supplied to the gas-liquid separator so that the methanol is separated from the carbon dioxide gas. After they are separated, the methanol is supplied to the fuel tank through a collection channel, and the carbon dioxide gas is supplied to a cathode channel through an exhaust gas path.

Although a gas-liquid separator has various separation systems, Jpn. Pat. Appln. KOKAI Publication No. 4-4002, for example, proposes a gas-liquid separator composed of a tube which is formed of porous gas permeable membranes as a gas-liquid separator which is resistant to an inclining condition and suitable for reduction in size. The tube is arranged across a flow of a liquid as well as an inside thereof having a pressure reduced by an exhaust gas device. With this arrangement, gas contained in the liquid is exhausted into the tube through gas-liquid separation membranes of the tube and separated from the liquid.

Further, Jpn. Pat. Appln. KOKAI Publication No. 2006-269155 proposes a fuel cell system arranged such that a temperature of generated water supplied to an evaporation chamber of a gas-liquid separator is increased by a heater to a temperature at which impurities in the generated water are evaporated and discharged as impurity gas.

In the fuel cell apparatuses arranged as described above, the fuel separated by the gas-liquid separator is returned to the fuel tank and used again for electricity generation. Accordingly, in order to effectively use the fuel, it is necessary for the gas-liquid separator interposed between the electromotive section and the fuel tank to efficiently and securely separate a fuel from carbon dioxide gas.

However, since gas-liquid separation using gas permeable membranes ordinarily employs such a system that gas is forcibly exhausted to the outside of a system through the membranes making use of a pressure difference therebetween, a gas separating ratio is lowered when a substance which disturbs that gas passes through the membranes is deposited on the surfaces of the membranes. Exemplified as the deposited substance is mainly water which is dewed by that vapor in separated gas is condensed. An anode fuel circulation system of a fuel cell apparatus has a relatively high temperature, and gas separated by a gas-liquid separator contains a lot of vapor just after it is separated. Accordingly, when the separated gas is cooled, the vapor is dewed and deposited on the surfaces of gas permeable membranes that constitute the gas-liquid separator. Then, since holes of the gas permeable membranes are filled with the dewed water, channels of the gas is clogged with the dewed water. As a result, gas/fluid separation efficiency of the gas-liquid separator is lowered.

To prevent occurrence of the dewed water, it is considered to keep the gas-liquid separator at a high temperature by heating it by an independent heating element such as a heater. However, provision of the independent heating element is not practical because it consumes a large amount of power by itself, and further the heating element becomes a bottleneck when a fuel cell apparatus is arranged compact.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing a portable computer according to a first embodiment of the present invention;

FIG. 2 is an exemplary view schematically showing internal structures of the portable computer and a fuel cell apparatus;

FIG. 3 is an exemplary perspective view showing a heating member, a radiator mechanism, and a gas-liquid separator in the portable computer;

FIG. 4 is an exemplary exploded perspective view showing the heating member, the radiator mechanism, and the gas-liquid separator in the portable computer;

FIG. 5 is an exemplary sectional view showing a cell stack of the fuel cell apparatus;

FIG. 6 is an exemplary view schematically showing a single cell of the cell stack;

FIG. 7 is an exemplary sectional view showing a gas-liquid separator of the fuel cell apparatus;

FIG. 8 is an exemplary side elevational view schematically showing a heating member and a gas-liquid separator of a portable computer according to a second embodiment of the present invention; and

FIG. 9 is an exemplary side elevational view schematically showing a heating member and a gas-liquid separator of a portable computer according to a third embodiment of the present invention.

### DETAILED DESCRIPTION

Various embodiments according to the invention will be described hereinafter with reference to the accompanying drawings. In general, according to one embodiment of the invention, an electronic apparatus system comprises: an electronic apparatus comprising a cabinet and a heating member provided in the cabinet; and a fuel cell apparatus including a electromotive section which comprises an anode and a cathode and is configured to generate electricity by a chemical reaction, a fuel tank configured to store a fuel, a circulation system having a fuel channel which is configured to circulate a fuel supplied from the fuel tank through the anode of the electromotive section and an air channel which is configured to supply air through the cathode of the electromotive section, and a gas-liquid separator which is arranged between a flow-out end of the electromotive section and the fuel tank in the fuel channel, configured to separate a gas-liquid two-phase fluid discharged from the anode to a liquid and gas, and is thermally coupled to the heating member to be heated by the heat of the heating member.

Embodiments of the present invention will be described in detail referring to the drawings.

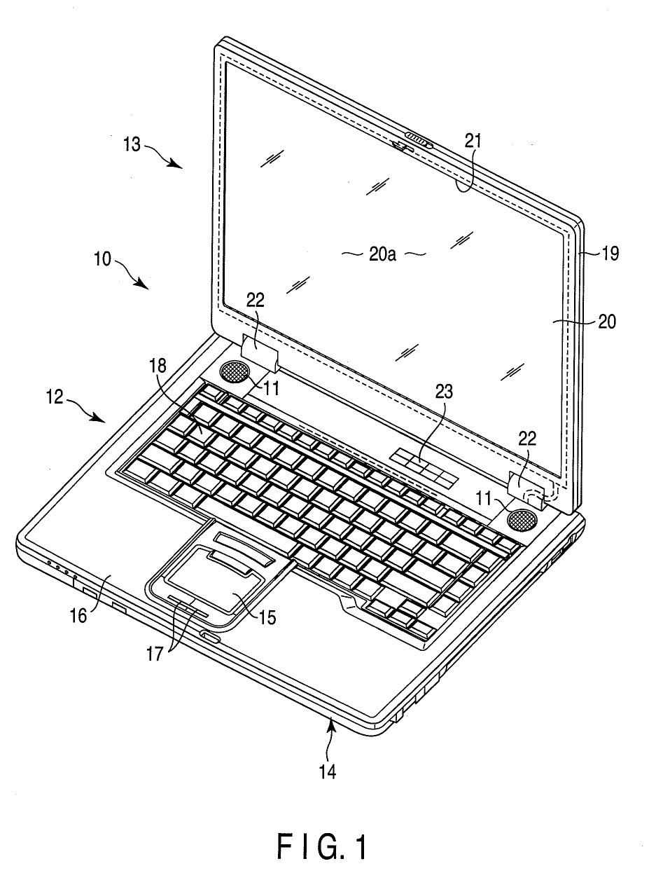

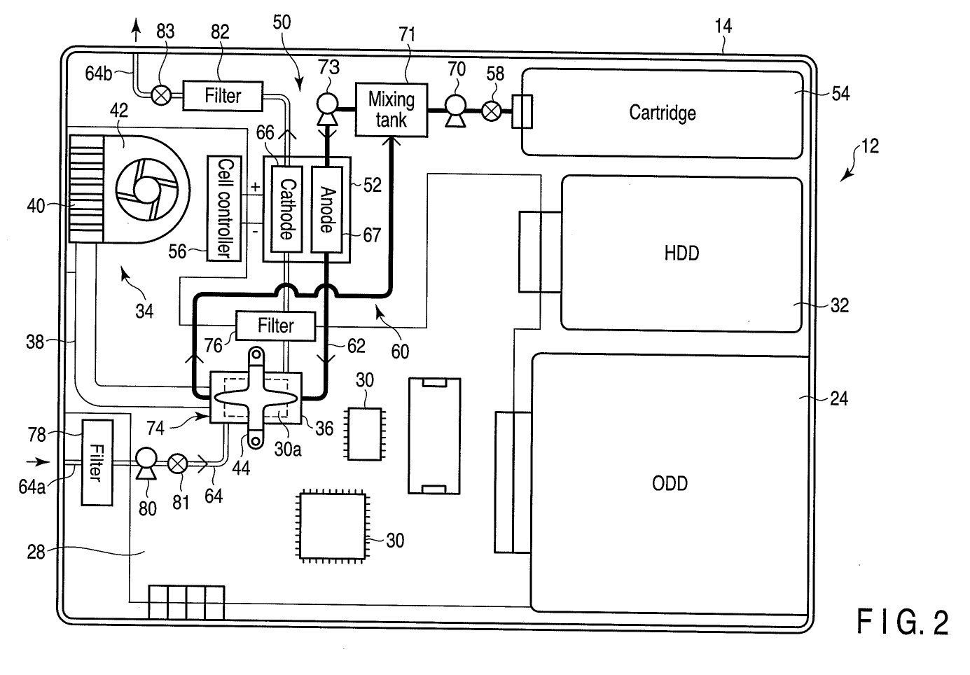

FIG. 1 shows a portable computer having a fuel cell apparatus as an electronic apparatus system according to a first embodiment of the present invention, and FIG. 2 schematically shows an internal structure of the portable computer.

As shown in FIG. 1, the portable computer 10 has an apparatus main body 12 and a display unit 13 supported by the apparatus main body 12. The apparatus main body 12 has a flat rectangular cabinet 14 formed of, for example, a synthetic resin. A palm rest 16 is formed on an upper surface of the cabinet 14, a touchpad 15 and click buttons 17 are disposed at an approximate center of the palm rest. A keyboard 18 is arranged at a rear portion of the palm rest 16. Speakers 11 are disposed on and exposed from an upper surface of the cabinet 14 on the right and left sides of a rear end thereof, respectively. A plurality of LEDs 23 are disposed at the rear end of the upper surface of the cabinet 14 to show operation states of the portable computer 10 and the fuel cell apparatus to be described later.

The display unit 13 has a flat rectangular box-shaped housing 19 and a liquid crystal display panel 20 arranged in the housing 19. A display surface 20a of the liquid crystal display panel 20 is exposed to the outside through a display window 21 formed in the housing 19. The housing 19 is pivotably supported on the rear end of the cabinet 14 by a pair of hinges 22 disposed thereon. With this arrangement, the display unit 13 can be pivoted between a closed position, at which it is lowered so as to cover the keyboard 18 from above it, and an open position at which it stands up rearward of the keyboard.

As shown in FIGS. 1 and 2, various components of the portable computer 10 as electronic apparatus are arranged within the cabinet 14. For example, a printed circuit board 28 constituting a mother board is arranged within the cabinet 14. A plurality of semiconductor devices 30 including a MPU 30a, a modem board, a modem connector, a USB board, and the other various electronic components are mounted on the printed circuit board 28.

Further, for example, an optical disc drive 24 and a hard disk drive 32 are provided within the cabinet 14 as storage units as well as a radiator mechanism 34 for cooling the MPU 30a as a heating member is located within the cabinet 14. The radiator mechanism 34 has a radiation plate (heat block) 36 acting as a heat receiving portion, a heat pipe 38, radiator fins 40, and a cooling fan 42 for cooling the radiator fins.

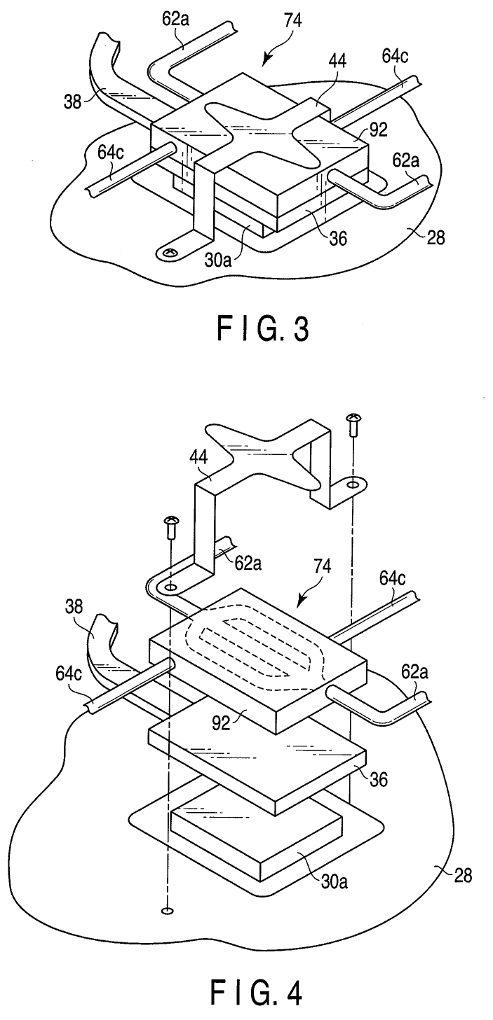

As shown in FIGS. 2 and 3, the radiation plate 36 is formed in an approximately rectangular shape by metal having a high thermal conductivity, for example, aluminum and the like. The radiation plate 36 is formed sufficiently larger than a flat area of the MPU 30a. The radiation plate 36 is overlapped on the MPU 30a through a heat transfer sheet (not shown) and thermally coupled to the MPU. The radiation plate 36 is held on the printed circuit board 28 by a metal sheet spring 44 together with a gas-liquid separator to be described later and elastically pressed to the MPU 30a.

The radiation plate 36 is thermally coupled to the radiator fins 40 through the heat pipe 38. The radiator fins 40 are arranged adjacent to a sidewall of the cabinet 14 in confrontation therewith. The radiator fins 40 are provided in an opening formed in the sidewall of the cabinet 14 and confront the cooling fan 42.

When heat is generated from the MPU 30a by an operation of the portable computer 10, the radiation plate 36 is heated by the heat. With this operation, the MPU 30a is cooled. The heat of the radiation plate 36 is transferred to the radiator fins 40 through the heat pipe 38. Further, the cooling fan 42 is operated, and cooling air is blown from an exhaust air port of the cooling fan to the radiator fins 40. With this operation, the heat transferred to the radiator fins 40 is radiated to the outside of the cabinet 14 from the radiator fins.

As shown in FIG. 2, the fuel cell apparatus 50 is disposed within the cabinet 14. The fuel cell apparatus 50 is constructed as a DMFC using methanol as a liquid fuel. The fuel cell apparatus 50 has a cell stack 52 constituting the electromotive section, a fuel tank 54, a circulation system 60 for supplying the fuel and air to the cell stack 52, and a cell controller 56 for controlling an operation of the overall fuel cell apparatus.

The fuel tank 54 has a hermetically sealed structure, and highly concentrated methanol is stored therein as the liquid fuel. The fuel tank 54 is formed as a fuel cartridge detachably mounted on the cabinet 14.

The circulation system 60 has an anode channel (fuel channel) 62 for circulating the fuel supplied from a fuel supply port of the fuel tank 54 through the cell stack 52, a cathode channel (air channel) 64 for circulating gas containing air through the cell stack 52, and a plurality of accessories arranged in the anode channel and in the cathode channel. The anode channel 62 and the cathode channel 64 are formed of pipings and the like, respectively.

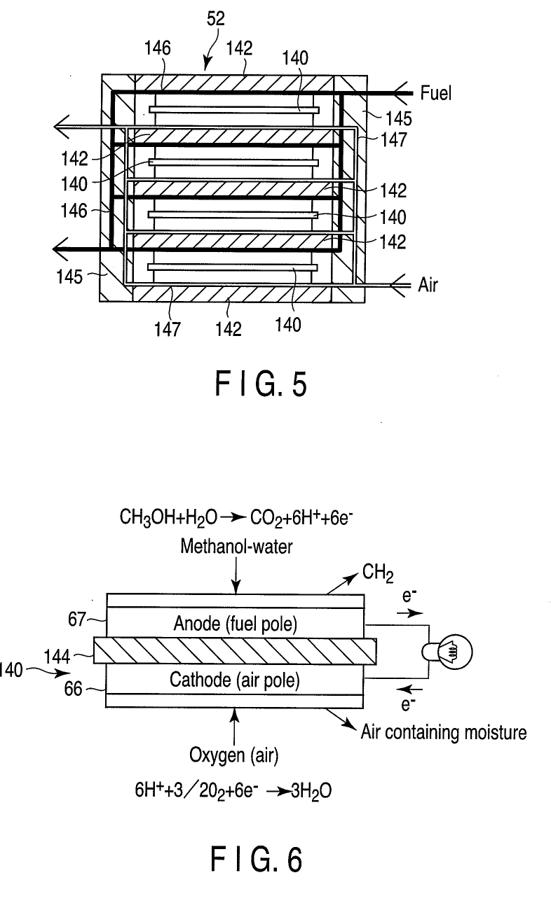

FIG. 5 shows a stacking structure of the cell stack 52, and FIG. 6 schematically shows an electricity generation reaction of respective cells. As shown in FIGS. 5 and 6, the cell stack 52 has a laminated body, which is arranged by alternately stacking a plurality of, for example, four single cells 140 and five rectangular sheet-shaped separators 142, and frame members 145 that support the laminated body. Each single cell 140 is provided with a membrane electrode assembly (MEA), which integrally includes a cathode (air electrode) 66, an anode (fuel electrode) 67, and a substantially rectangular polymer electrolyte membrane 144. The cathode 66 and the anode 67 are substantially rectangular plates that are each formed of a catalyst layer and a carbon paper. The polymer electrolyte membrane 144 is sandwiched between the cathode and the anode. The polymer electrolyte membrane 144 is larger in area than the anode 67 and the cathode 66.

Among the five separators 142, three separators 142 are laminated between the two adjacent single cells 140 and the other two separators are laminated to both the ends of the single cells 140 in the laminated direction thereof, respectively. A fuel channel 146 for supplying the fuel to the anodes 67 of the respective single cells 140 and an air channel 147 for supplying air to the cathodes 66 of the respective single cells are formed to the separators 142 and the frame member 145.

As shown in FIG. 6, the supplied fuel and air chemically react with each other in the polymer electrolyte membrane 144 that are interposed between the anode 67 and the cathode 66, whereupon electricity is generated between the anode and the cathode. The electricity generated in the cell stack 52 is supplied to the portable computer 10 through the cell controller 56.

As shown in FIG. 2, the accessories arranged in the anode channel 62 include an on-off valve 58 connected to the fuel supply port of the fuel tank 54 through a piping, a fuel pump 70, and a mixing tank 71 connected to an output portion of the fuel pump through a piping. Further, the accessory has a liquid feed pump 73 connected to an output portion of the mixing tank 71 constituting a part of the fuel tank 54. An output portion of the liquid feed pump 73 is connected to the fuel channel 146 of the cell stack 52 through the anode channel 62.

An output portion of the anode 67 of the cell stack 52 is connected to an input portion of the mixing tank 71 through the anode channel 62. A gas-liquid separator 74 is provided in the anode channel 62 between an output portion of the cell stack 52 and the mixing tank 71. A discharged fluid discharged from the anode 67 of the cell stack 52, that is, a gas-liquid two-phase fluid, which contains an unreacted methanol aqueous solution that is not used for the chemical reaction and generated carbon dioxide, is supplied to the gas-liquid separator 74 and separated to the unreacted methanol aqueous solution and the carbon dioxide as gas in the gas-liquid separator 74. The methanol aqueous solution from which the gas is separated is returned to the mixing tank 71 through the anode channel 62 and supplied to the anode 67 again. The carbon dioxide separated by the gas-liquid separator 74 is supplied to a gas purification filter 76 to be described later through the cathode channel 64.

In contrast, an upstream end 64a and a downstream end 64b of the cathode channel 64 communicate with the atmosphere, respectively. The accessories arranged in the cathode channel 64 has an air filter 78, which is provided in the vicinity of the upstream end 64a of the cathode channel 64 on an upstream side of the cell stack 52, an air feed pump 80, which is connected to the cathode channel between the cell stack 52 and the air filter 78, an on-off valve 81, an exhaust gas filter 82, which is provided in the vicinity of the downstream end 64b of the cathode channel 64 on a downstream side of the cell stack 52, and an on-off valve 83.

The air filter 78 captures and removes dust in air sucked into the cathode channel 64 and impurities, harmful substances, and the like such as carbon dioxide, formic acid, fuel gas, formic acid methyl. The exhaust gas filter 82 makes byproducts in gas exhausted from the cathode channel 64 to the outside unharmful as well as captures fuel gas and the like contained in the exhaust gas.

The gas-liquid separator 74 is connected to the cathode channel 64 between an inlet side of the cell stack 52 and the on-off valve 81. Further, the gas purification filter 76 is located in the cathode channel 64 between the gas-liquid separator 74 and the inlet side of the cell stack 52. The gas separated from the liquid by the gas-liquid separator 74 and supplied to the cathode channel 64, that is, the carbon dioxide and the air supplied by the air feed pump 80 pass through the gas purification filter 76 and supplied to the cell stack 52 after impurities and harmful substances such as fuel gas and carbon dioxide are removed therefrom in the gas purification filter 76.

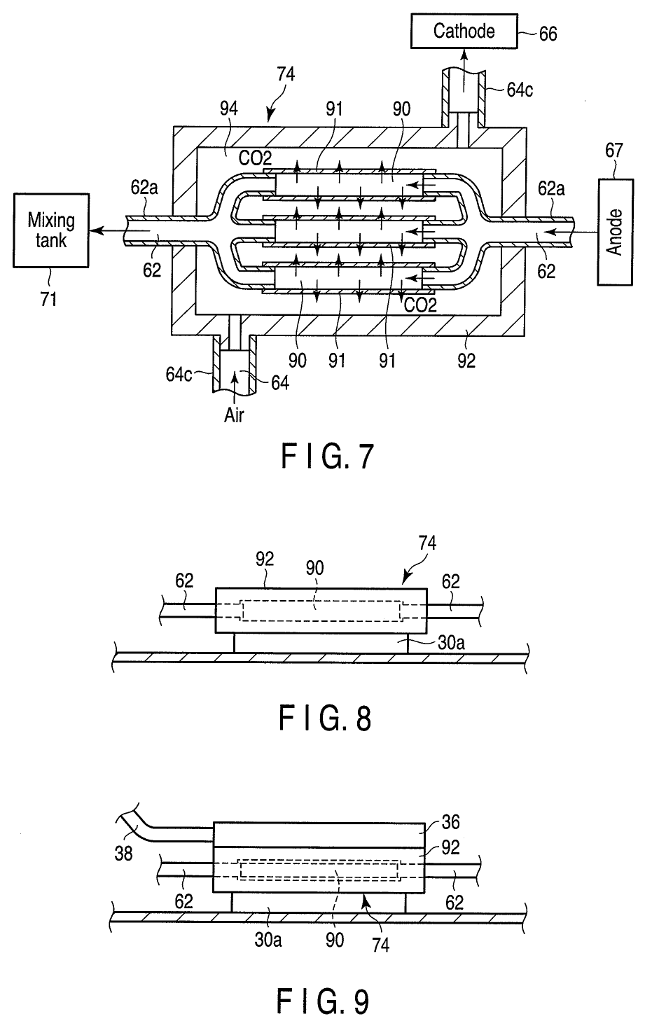

Next, the gas-liquid separator 74 will be explained in detail. FIG. 7 shows the gas-liquid separator 74 in enlargement.

As shown in FIG. 7, the gas-liquid separator 74 has, for example, three separator tubes 90 for defining a part of the anode channel 62 and a hollow external vessel 92 covering the separator tubes 90. Each separator tube 90 is formed by cylindrically molding a porous material, that is, a gas permeable membrane 91 having a thickness 1 to 2 mm and composed of, for example, a porous fluorine resin. A channel, in which the gas-liquid two-phase flow flows, is defined by an inner surface (first surface) of the gas permeable membrane 91, and an outer surface of the separator tube is formed by an outer surface (second surface) of the gas permeable membrane 91. The gas permeable membrane 91 causes the gas in the gas-liquid two-phase flow, which flows in the channel, to permeate therethrough.

The three separator tubes 90 are disposed at intervals parallel to each other. Both the ends of each separator tube 90 are connected to a piping 62a which forms the anode channel 62. With this arrangement, the separator tubes 90 constitute a part of the anode channel 62 through which the discharged fluid discharged from the anode 67, that is, the gas-liquid two-phase fluid which contains the unreacted methanol aqueous solution and the generated carbon dioxide flows.

The external vessel 92 houses the three separator tubes 90 in their entirety and defines a hermetically sealed space 94 which comes into contact with the outer surfaces of the separator tubes 90. The external vessel 92 is connected to the cathode channel 64 between the on-off valve 81 and the gas purification filter 76. The external vessel 92 is formed of a material having a high heat transfer property, for example, metal such as copper, stainless steel, and aluminum. A piping 64a, which defines the cathode channel 64, is connected to the external vessel 92, and the space 94 in the external vessel 92 communicates with the cathode channel 64. With this arrangement, outside air (air) supplied from the air feed pump 80 is supplied into the space 94 in the external vessel 92 and supplied to the cathode 66 through the gas purification filter 76 after it flows in the periphery of the separator tubes 90.

The gas-liquid separator 74 is arranged within the cabinet 14 in a state that the external vessel 92 thereof is thermally coupled to the MPU 30a which is a heat generation component. That is, as shown in FIGS. 3 and 4, the external vessel 92 is formed in a rectangular shape having a size approximately the same as that of the radiation plate 36. Then, the external vessel 92 is arranged in a state that, for example, one surface thereof is in surface contact with the radiation plate 36 and stacked on the MPU 30a across the radiation plate. The gas-liquid separator 74 is fixed to the printed circuit board 28 by the metal sheet spring 44 together with the radiation plate 36 and elastically pressed to the MPU 30a. Grease and the like having a high heat transfer property are filled between the radiation plate 36 and the external vessel 92. With this arrangement, the external vessel 92 receives heat from the MPU 30a through the radiation plate 36 and is heated thereby. Accordingly, air in the external vessel 92, that is, air in the periphery of the separator tubes 90 is heated to a temperature at which it is not dewed.

According to the gas-liquid separator 74 constructed as described above, the discharged fluid discharged from the anode 67 flows through the separator tubes 90, and the outer surfaces of the separator tubes 90 are in contact with the outside air, that is, the air supplied into the space 94. The discharged fluid has a relatively high temperature as well as a pressure higher than the outside air by several kPa. Thus, a pressure difference is caused between the inside and the outside of the separator tubes 90. As a result, the gas contained in the discharged fluid, here, the carbon dioxide and the gaseous methanol fuel component are caused to pass through the gas permeable membranes 91 by the pressure difference and discharged to the space 94 outside thereof. The liquid in the discharged fluid is prevented from passing through the gas permeable membranes 91 by the surface tension thereof and flows in the channel as it is. With this operation, the gas is separated from the fluid.

When a heat generation temperature of the MPU 30a is set to, for example, 50 to 80° C. at the time the portable computer 10 is operated, the radiation plate 36 and the external vessel 92 of the gas-liquid separator 74 are heated to a temperature of 45° C. or more, here, 60° C. or more and kept at a high temperature. As a result, air in the periphery of the separator tubes 90 is heated to a temperature at which water is not condensed in the external vessel 92. Accordingly, the vapor contained in the gas separated by the gas permeable membranes 91 can be suppressed from being dewed. As a result, since holes of the gas permeable membranes 91 are prevented from being clogged with dewed water, gas permeability of the gas permeable membranes, that is, gas/fluid separation efficiency can be suppressed from being lowered. Further, the gas-liquid separator 74 can act also as a cooling member for cooling the MPU 30a by receiving heat from the MPU 30a.

The discharged fluid separated by the gas-liquid separator 74 as described above is supplied to the mixing tank 71 through the anode channel 62. Further, the separated gas is supplied to the gas purification filter 76 together with the outside air and then supplied to the cathode 66 of the cell stack 52 after impurities and the like are removed therefrom in the gas purification filter 76.

When the portable computer 10 is operated using the fuel cell apparatus 50 arranged as described above as a power supply, the fuel pump 70, the liquid feed pump 73, and the air feed pump 80 are operated under the control of the cell controller 56 as well as the on-off valves 58, 81, 83 are opened. Methanol is supplied from the fuel tank 54 into the mixing tank 71 by the fuel pump 70 and mixed with water in the mixing tank, thereby a methanol aqueous solution having a desired concentration is made. Further, the methanol aqueous solution in the mixing tank is supplied to the anode 67 of the cell stack 52 through the anode channel 62 by the liquid feed pump 73.

In contrast, outside air, that is, air is sucked from the upstream end 64a of the cathode channel 64 by the air feed pump 80. The air passes through the air filter 78, and dust and impurities in the air are removed in the air filter 78. After the air passes through the air filter 78, it is supplied to the gas-liquid separator 74 passing through the cathode channel 64. Further, the air is supplied to the gas purification filter 76 together with the exhaust gas, which is separated by the gas-liquid separator and exhausted from the cell stack 52, and supplied to the cathode 66 of the cell stack 52 after it is purified in the gas purification filter 76.

The methanol and the air supplied to the cell stack 52 electrochemically react with each other in the electrolytic membrane 144 interposed between the anode 67 and the cathode 66, thereby electricity is generated between the anode 67 and the cathode 66. The electricity generated in the cell stack 52 is supplied to a computer main body through the cell controller 56.

In the cell stack 52, carbon dioxide is generated on the anode 67 side and water is generated on the cathode 66 side by the electrochemical reaction as reaction products. The carbon dioxide generated on the anode 67 side and the unreacted methanol aqueous solution which is not used by the chemical reaction are supplied to the gas-liquid separator 74 through the anode channel 62 and separated to carbon dioxide and a methanol aqueous solution in the gas-liquid separator 74. The separated methanol aqueous solution is collected from the gas-liquid separator 74 to the mixing tank 71 through the anode channel 62 and used again for electricity generation.

The separated carbon dioxide is supplied from the gas-liquid separator 74 to the cathode channel 64 and further supplied to the gas purification filter 76 together with air. After impurities in the air and harmful substances contained in carbon dioxide are removed by the gas purification filter 76, the air and the carbon dioxide are supplied to the cell stack 52 and used for electricity generation. As a result, since the impurities in the air are prevented from being supplied to the cell stack 52, electricity generation efficiency can be prevented from being lowered by these impurities.

At the time, as described above, heat from the MPU 30a, which is the heating member of the portable computer, is applied to the gas-liquid separator 74 by the radiation plate 36 of the radiator mechanism 34 so that a temperature, at which the air in the external vessel 92 is not dewed, is kept. As a result, separation efficiency in the gas-liquid separator 74 is suppressed from being lowered and a high gas-liquid separation performance is kept.

When the MPU 30a has a large heat value and heat cannot be sufficiently radiated only by transferring the heat to the radiation plate 36 and the gas-liquid separator 74, the cooling fan 42 is operated when the MPU 30a generates heat of, for example, 80° C. or more. With this operation, the heat of the radiation plate 36 is transferred to the radiator fins 40 through the heat pipe 38, and further cooling air is blown to the radiator fins from the cooling fan 42. The heat transferred to the radiator fins 40 is radiated to the outside of the cabinet 14. With this operation, the MPU 30a is kept to a temperature of, for example, 80° C. or lower.

Almost all the water generated on the cathode 66 side of the cell stack 52 is made to vapor and discharged to the cathode channel 64 together with air. The discharged air and vapor are supplied to the exhaust gas filter 82 and exhausted from the downstream end 64b of the cathode channel 64 to the outside after dust and impurities are removed therefrom in the exhaust gas filter 82.

According to the portable computer arranged as described above, the gas-liquid separator 74 is heated making use of the heat of the heating member which exists on the electronic apparatus side as a heat source and a temperature, at which air in the periphery of the separator tube is not dewed, is kept, thereby a high separation performance of the gas-liquid separator can be kept. Thus, it is not necessary to provide an independent heater and the like for heating the gas-liquid separator. As a result, since the gas in the two-phase fluid can be effectively separated without increasing power consumption of the portable computer and without increasing a size thereof, an electronic apparatus system having improved electricity generation efficiency can be obtained.

FIG. 8 schematically shows a gas-liquid separator portion of a portable computer according to a second embodiment of the present invention. According to the second embodiment, a gas-liquid separator 74 is arranged in a state that an external vessel 92 thereof comes into direct contact with a heating member, for example, a MPU 30a of electronic apparatus.

According to a portable computer of a third embodiment shown in FIG. 9, a gas-liquid separator 74 is arranged in a state that an external vessel 92 thereof comes into direct contact with a heating member, for example, a MPU 30a of electronic apparatus. Further, a radiation plate 36 of a radiator mechanism is overlapped on the gas-liquid separator 74.

Note that since the other arrangements of the second and third embodiments are the same as those of the first embodiment described above, the same components are denoted by the same reference numerals and the detailed explanation thereof is omitted.

Since gas in a two-phase fluid can be effectively separated without increasing power consumption of the portable computer and without increasing a size thereof also in the second and third embodiments arranged as described above, an electronic apparatus system having improved electricity generation efficiency can be obtained.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, the external vessel of the gas-liquid separator is not limited to a case that it is formed of metal in its entirety, and only a portion thereof which receives heat from the heating member may be formed of a material having a high heat transfer property such as metal. The number of the separator tubes of the gas-liquid separator is not limited to three and may be one, two, or four or more. Further, a shape of the gas permeable membranes is not limited to the cylindrical shape and may be formed in a plane shape so that an interior of the external vessel may be separated to a space, in which the gas-liquid two-phase fluid flows, and a space, in which outside air flows, by the gas permeable membranes.

The electronic apparatus system may be applied to other electronic apparatus in addition to the portable computer. The heating member provided in the electronic apparatus is not limited to the MPU and may be other member which generates a high temperature such as a CPU, a northbridge, a graphic board, and the gas-liquid separator may be heated making use of heat exhausted therefrom. A type of the fuel cell is not limited to the DMFC and may be other type such as Polymer Electrolyte Fuel Cell (PEFC)

What is claimed is:

1. An electronic apparatus system comprises:
an electronic apparatus comprising a cabinet and a heat generating component in the cabinet; and
a fuel cell apparatus comprising:
an electromotive module comprising an anode and a cathode and configured to generate electricity by a chemical reaction;
a fuel tank configured to store a fuel;
a circulation system comprising a fuel channel configured to circulate a fuel supplied from the fuel tank through the anode of the electromotive module and an air channel configured to supply air through the cathode of the electromotive module; and
a gas-liquid separator between a flow-out end of the electromotive module and the fuel tank in the fuel channel, configured to separate a gas-liquid two-phase fluid discharged from the anode to a liquid and gas, thermally coupled to the heat generating component and configured to be heated by the heat of the heat generating component.

2. The electronic apparatus system of claim 1, wherein the gas-liquid separator comprises:
a gas permeable membrane formed of a porous material and configured to define a channel through which the gas-liquid two-phase fluid is configured to flow; and
an external vessel configured to cover the gas permeable membrane and to define a channel in which gas in the gas-liquid two-phase fluid passed through the gas permeable membrane is configured to flow, the external vessel being thermally coupled to the heat generating component.

3. The electronic apparatus system of claim 2, wherein the external vessel is configured to directly contact with the heat generating component.

4. The electronic apparatus system of claim 2, further comprising a radiator comprising a heat receiving portion in contact with the heat generating component and configured to radiate heat from the heat generating component, wherein the gas-liquid separator is thermally coupled with the heat receiving portion.

5. The electronic apparatus system of claim 4, wherein the radiator comprises radiator fins thermally coupled to the heat receiving portion and a cooling fan configured to supply cooling air to the radiator fins.

6. The electronic apparatus system of claim 3, wherein at least a portion of the external vessel thermally coupled to the heat generating component is formed of metal.

7. The electronic apparatus system of claim 2, wherein the gas permeable membrane is of a cylindrical shape and comprises a separator tube configured to define a portion of the fuel channel through which the gas-liquid two-phase fluid is configured to flow and the external vessel is configured to cover outside of the separator tube.

8. The electronic apparatus system of claim 7, wherein the gas-liquid separator comprises a plurality of separator tubes each defining a portion of the fuel channel.
